(19) United States
(12) Patent Application Publication
(10) Pub. No.: US 2013/0158929 A1
(43) Pub. Date: Jun. 20, 2013

(54) Optical Measurement Device Calibration

(71) Applicants: Nathan Moroney, Palo Alto, CA (US); Ehud Chatow, Palo Alto, CA (US); Kok-Wei Koh, Mountain View, CA (US)

(72) Inventors: Nathan Moroney, Palo Alto, CA (US); Ehud Chatow, Palo Alto, CA (US); Kok-Wei Koh, Mountain View, CA (US)

(73) Assignee: HEWLETT-PACKARD DEVELOPMENT COMPANY, L.P., Houston, TX (US)

(21) Appl. No.: 13/818,973

(22) PCT Filed: Sep. 18, 2010
(86) PCT No.: PCT/US10/49411

§ 371 Date: Feb. 25, 2013

(51) Int. Cl. G01D 18/00; G06F 17/00

(52) U.S. Cl. CPC G01D 18/00; G06F 17/00
USPC 702/104

(57) ABSTRACT

Optical measurement device calibration systems and methods are disclosed. An exemplary method includes receiving calibration information from a plurality of optical measurement devices (200) at a central data store (124), the calibration information comprising at least real-time measurement data stored on the plurality of optical measurement devices, the plurality of optical measurement devices each at different print facilities. The method also includes analyzing at least one trend in the calibration information at the central data store. The method also includes issuing an instruction to at least one of the plurality of optical measurement devices to update a calibration parameter in the at least one optical measurement device based on the at least one trend.

### BACKGROUND

Print service providers (PSPs) fulfill the demand for traditional print services by printing everything from photographs, brochures, and course materials to product packaging. Consistency in product appearance is important, for example, so that all cereal boxes of the same brand and type of cereal appear to have the same or similar packaging (e.g., color, tone, brightness, and so forth). In a modern PSP facility, optical measurement devices are used to scan samples and actual printed product. This optical measurement data is typically checked by a quality assurance (QA) officer at various times during print production to help ensure the desired product appearance prior to shipping.

### BRIEF DESCRIPTION OF THE DRAWINGS

FIG. 1 is a high-level illustration of an exemplary networked calibration system which may be implemented for optical measurement device calibration.

FIG. 2 is a high-level illustration of an exemplary optical measurement device.

FIG. 2a is a simplified circuit diagram illustrating internal components of the exemplary optical measurement device shown in FIG. 2.

FIG. 3 is a block diagram illustrating exemplary program code which may be implemented for optical measurement device calibration.

FIG. 4 is a flowchart illustrating exemplary operations which may be implemented for optical measurement device calibration.

### DETAILED DESCRIPTION

A number of factors can affect the optical measurement data. Variation in temperature, humidity, batches of substrate stock, ink composition, and the printer machines, to name only a few examples, affect the appearance of the printed product. Accordingly, each print facility typically maintains a standard for calibrating the optical measurement device, and updates the calibration of the optical measurement device on a predetermined schedule. Calibration drift generally results over time and may cause the optical measurement data to appear satisfactory when in fact the product appearance is no longer meeting expectations because the optical measurement device is no longer producing accurate readings.

To help identify calibration drift, the QA officer may, from time to time, transfer optical measurement data to a spreadsheet for comparison to earlier calibration data. But this feedback is typically delayed in nature. Delayed feedback based on limited data such as this may result in already printed product having to be disposed of or recycled, or even worse, returning or recalling product that has already been delivered to the customer.

PSPs typically handle color management in an autonomous mode. That is, each optical measurement device is a stand-alone unit and used to perform measurements in isolation. Analysis of the measurements is typically also done on an individual basis. Embodiments are disclosed herein having “opt-in” optical measurement devices communicatively coupled with one another via a central data management system. The central data management system may include at least a central data store and a processor with associated computer readable storage, the processor configured to execute program code to analyze calibration information from one or more optical measurement device and provide real-time feedback to the optical measurement devices to enhance efficiency and help ensure collective QA standards are met.

Exemplary embodiments may reduce or altogether eliminate difficulty and/or expense associated with: estimating variation and calibration among uncalibrated (e.g., new) optical measurement devices; estimating average color reproduction among different optical measurement devices, and estimating initial and refined spot color matches for a known device/substrate/ink set among different optical measurement devices. Exemplary embodiments may also enhance QA auditing, and standardizing QA across multiple print facilities. These and other features will now be described in more detail with reference to the drawings.

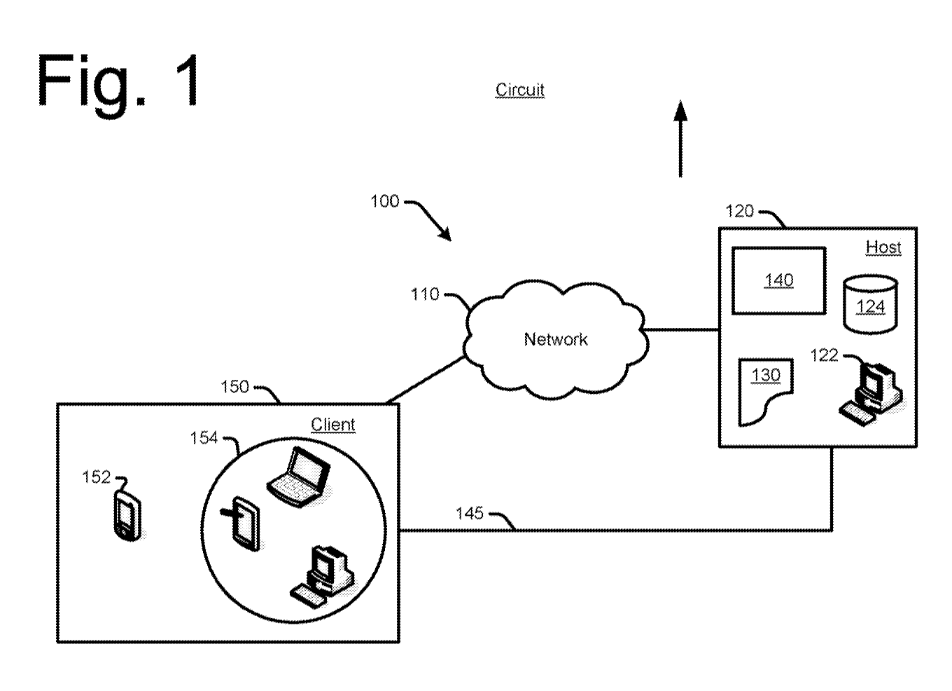

FIG. 1 is a high-level illustration of an exemplary networked calibration system 100 which may be implemented for optical measurement device calibration. The networked calibration system 100 may include one or more communication networks 110, such as a local area network (LAN) and/or wide area network (WAN). A host 120 may be implemented in the networked calibration system 100.

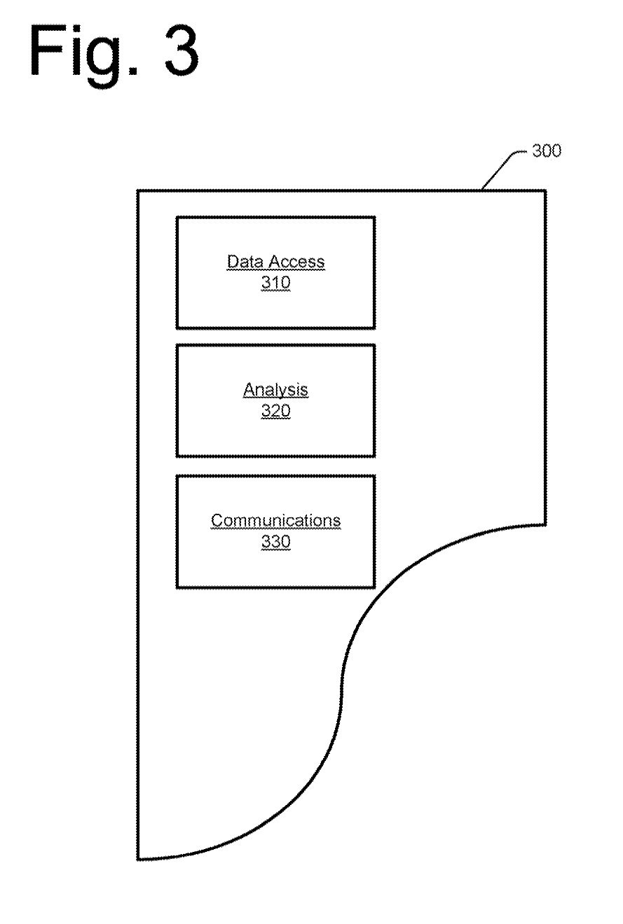

Host 120 may include one or more computing systems, such as a server 122 operatively associated with a data store 124. Host 120 may execute a host application 130 implemented in software and stored on computer-readable storage, as described in more detail below with reference to FIG. 3. Host 120 may also provide services to other computing or data processing systems or devices. For example, host 120 may also provide transaction processing services, email services (e.g., for notifications), etc.

Host 120 may be provided on the network 110 via a communication connection, such as via an Internet service provider (ISP). Host 120 may be accessed directly via the network 110, or via a network site 140. In an exemplary embodiment, network site 140 may also include a web portal on a third-party venue (e.g., a commercial Internet site), which facilitates a connection with host 120 (e.g., via back-end link 145). In another exemplary embodiment, portal icons may be provided (e.g., on third-party venues, pre-installed on computer or appliance desktops, etc.) to facilitate a direct link to the host 120.

The term “client” 150 as used herein refers to a computing device through which one or more users may access the host service. The client may be the optical measurement device 152 itself, and/or a local server or other computing device 154 which connects the optical measurement device(s) locally to the host 120. In either case, client 150 includes at least the optical measurement device 152, and may also include any of a wide variety of computing systems 154, such as a stand-alone personal desktop or laptop computer (PC), workstation, personal digital assistant (PDA), so-called “smart phone” or appliance, to name only a few examples. Indeed, a smart phone may be used as the optical measurement device to gather optical measurement data and send/receive communications with the host 120.

In any event, the client computing devices may include a degree of data processing capability at least sufficient to manage a connection to the host application 130 either directly via network 110 or indirectly (e.g., via network site 140). Client computing devices may connect to network 110 via a communication connection, such as a wireless, cable, or DSL connection via an Internet service provider (ISP). Client computing devices may also include other components and capabilities (e.g., computer-readable storage).

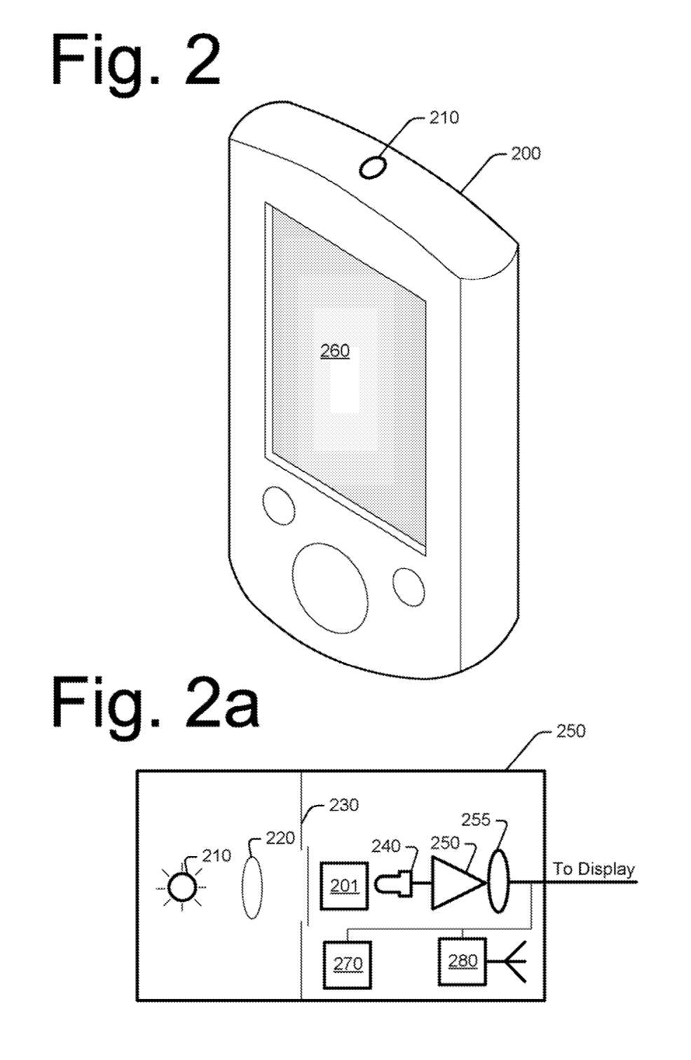

FIG. 2 is a high-level illustration of an exemplary optical measurement device 200 (e.g., device 152 in FIG. 1), as it may be embodied as a spectrophotometer or colorimeter. FIG. 2a is a simplified circuit diagram 250 illustrating internal components of the exemplary optical measurement device 200 shown in FIG. 2. In its basic form, the optical measurement device 200 includes a light source 210 (unless natural or background light is being used), a lens 220 (e.g., a prism for separating light into an analytical color spectrum), an aperture 230 (e.g., an adjustable aperture for controlling the amount of light that reaches the sample), and photodetector(s) or photosensor(s) 240. In use, the sample 201 to be analyzed may be inserted along the light path, typically between the aperture 230 and photosensor(s) 240. The photosensor 240 converts the light signal into an electronic signal. An amplifier 250 and filter 255 may be provided to amplify the electronic signal and filter any noise, respectively, in the output provided, e.g., to display 280.

More sophisticated circuitry and/or firmware may also be provided (e.g., to implement Fourier transform of the spectral data). However, these are not discussed in detail here because the exact configuration of the optical measurement device 200 is not required or limiting of the present embodiments. That is, the embodiments described herein may be implemented with any suitable optical measurement devices now known or later developed, as will be readily appreciated by those having ordinary skill in the art after becoming familiar with the teachings herein.

In addition to the basic components described above, optical measurement device 200 may also include onboard storage 270 (e.g., RAM or an SD card) and a communications module 280. In one embodiment, the communications module 280 may facilitate a wired or wireless connection with a local sending device (such as a computer 154 shown in FIG. 1), and the local sending device is configured to establish a remote connection with the host (e.g., host 120 executing host application 130 discussed above with reference to FIG. 1), In another embodiment, the communications module 280 may facilitate a communications connection directly with the host. Optical measurement device 200 may also include other sensors (e.g., temperature/humidity sensors, background light sensors, etc.).

In use, the optical measurement device 200 may need to be calibrated and/or recalibrated in order to produce the desired output. The optical measurement device 200 may also be implemented for coordination between print facilities, and for other uses described in more detail below. In any event, the host receives calibration information and/or other data from the optical measurement device at the data store for analysis by program code executing at the host.

FIG. 3 is a block diagram illustrating exemplary program code 300 which may be implemented for optical measurement device calibration (e.g., host application 130 referred to in the above discussion of FIG. 1). The program code 300 may be implemented in any suitable form, including but not limited to, computer software, web-enabled or mobile applications or “apps”, so-called “widgets,” and/or embedded code such as firmware. Although the program code is shown in FIG. 3 comprising a number of components or modules for purposes of illustration herein, the program code is not so limited. The program code may include additional components, modules, routines, subroutines, etc. In addition, one or more functions may be combined into a single component or module.

In an exemplary embodiment, the program code may include a data access module 310. Data access module 310 may be executed to access calibration information and/or other data from the data store at the host.

An analysis module 320 may be provided to implement color science (e.g., standard comparisons, ink “recipe” generation, profiles) and other analysis (e.g., trends, estimation, and statistical data development) of the calibration information received from each of the optical measurement devices at the data store. The analysis module 320 may also generate instructions which may be issued to the client (e.g., the optical measurement device). These instructions may include calibration updates (e.g., to update a calibration parameter in the optical measurement device), print processing updates (e.g., adjustments to the ink “recipe” or processing parameters such as dry time), and so forth. The analysis module 320 may also be used with historical and real-time data.

The analysis module 320 may also be used to register new optical measurement devices in the system. In an exemplary embodiment, the analysis module may receive registration information from one of the optical measurement devices when the optical measurement devices is brought online (e g., for the first time or after being reset following repair). The analysis module 320 may generate an instruction based in part on the device registration information and in part on collective device calibration information. Registration may also enable an “opt-in” approach, wherein one or more of the optical measurement devices may be registered and other optical measurement devices are not registered. Such an embodiment may be used to opt-in devices which are used for particular projects or customers. Similarly, particular devices may be registered for use only with a particular project or customer, so as not to mix data between projects and/or customers.

The analysis module 320 may also be used to maintain threshold boundaries. Threshold boundaries may include operating parameters for which the optical measurement device is considered to be operating properly and does not need to be re-calibrated.

A communications module 330 may be provided to facilitate communications with the client (e.g., the optical measurement device). For example, communications module 330 may issue instructions generated by the analysis module 320.

The program code may be executed to carry out one or more use-cases. Although other use-cases are also contemplated, the following use-cases are provided as exemplary.

In a first use-case, the plurality of optical measurement devices are initially calibrated in the field at the different print facilities based on analysis of the calibration information at the central data store. Initial calibration may take place when a new system is deployed across one or more print facilities for a particular print manufacturer. initial calibration may also take place when a new print facility is added to existing print facilities for a particular print manufacturer. Initial calibration may also take place when a new optical measurement device is brought online, either to replace an existing optical measurement device, or to add additional optical measurement device(s). For example, additional optical measurement device(s) may be added as backup devices to reduce or altogether eliminate downtime should one of the optical measurement devices being used become inoperable or need to be recalibrated. Additional optical measurement device(s) may also be added for use at different stations (e.g., on different floors or different locations) at a large print facility. Also considered part of the first use-case is updating the calibration of optical measurement devices based on internal control parameters (i.e., internal to the optical measurement devices), for example, due to drift or to prevent drift outside of a threshold boundary, replacing an optical sensor, and the like.

In a second use-case, the plurality of optical measurement devices are already calibrated (e.g., as in the first use-case). The plurality of optical measurement devices are then updated based on external control parameter (i.e., external to the optical measurement devices). External control parameters may include, but are not limited to, changing operating parameters (e.g., a new print machine being brought online, changing vendors for ink or substrate stock), environmental factors (e.g., seasonal changes), or implementation of different QC standards (e.g., based on customer demands), and the like.

In a third use-case, the plurality of optical measurement devices provide optical measurements for developing consistent ink composition specific to each of the different print facilities, In this case: data collected by the optical measurement device(s) at a particular print facility are received at the central data store and analyzed relative to a standard and/or the other print facilities. Adjustments to the printing “recipe” (e.g., amount and color of ink, drying time) are determined based on information specific to the particular print facility (e.g., signature of the substrate stock, environmental conditions, print machine parameters) and delivered to the print facility. This may be repeated for each of the print facilities handling a particular print job so that the print product meets QC standards for the entire print job, even though that print job may be distributed across multiple print facilities.

For example, a print job may be for a large corporation's letterhead to be used at multiple facilities worldwide. Rather than print all of the letterhead at a single print facility, the PSP may determine that it is more efficient to print the order at multiple print facilities (e.g., at locations near the customer's different facilities). The customer may require that their logo be printed according to certain standards, including that it be a “Factory Blue” color. In order to help ensure a consistent color regardless of variations at the different print facilities (e.g., in substrate stock, environment, print machines), optical measurement data in the central data store from each of the different print facilities may be analyzed and the printing “recipe” adjusted to accommodate these variations in the different print facilities so that the resulting print product has a consistent appearance. In this example, the letterhead is printed in a “Factory Blue” color that appears to be the same color regardless of which print facility the letterhead was printed at. The “Factory Blue” target color may be composed of a predefined mix of three out of eleven basic color inks, with a specific amount of each of the three inks defined to create the target color.

Before continuing, it is noted that the systems and devices discussed above are merely intended to be representative of various embodiments which may be implemented for optical measurement device calibration. Still other physical embodiments are contemplated and will become readily apparent to those having ordinary skill in the art after becoming familiar with the teachings herein based at least in part on desired implementations and the current state of the art for the various components.

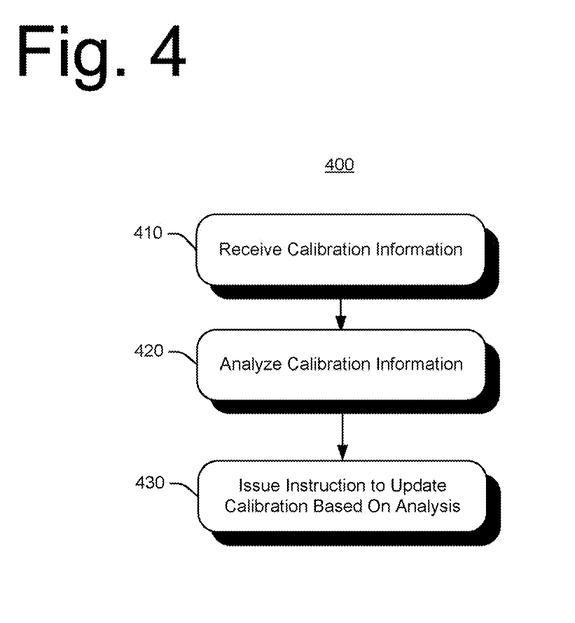

FIG. 4 is a flowchart illustrating exemplary operations which may be implemented for optical measurement device calibration. Operations 400 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used,

In operation 410, calibration information is received from a plurality of optical measurement devices at a central data store. The plurality of optical measurement devices may be physically located at different print facilities. The calibration information may comprise at least real-time measurement data stored on the optical measurement devices.

In operation 420, the calibration information at the central data store is analyzed for at least one trend. In operation 430, an instruction is issued to at least one of the plurality of optical measurement devices to update a calibration parameter in the at least one optical measurement device based on the at least one trend.

The operations shown and described herein are provided to illustrate exemplary implementations of optical measurement device calibration, It is noted that the operations are not limited to the ordering shown. Still other operations may also be implemented, such as but not limited to, the following.

By way of example, the method may also include receiving registration information from an optical measurement device when the optical measurement devices come online for the first time. The registration information may include, but is not limited to, device name, manufacturer, manufacture date, optics range, transmission spectra, power requirements, and so forth. An initialization process may then be implemented, wherein an initialization instruction is issued to the optical measurement device. The initialization instruction may be based in part on the device registration information and in part on collective device calibration information may be issued to the optical measurement device. The initialization instruction may include, but is not limited to, initial calibration information, network information, timing information for transmitting optical measurement data, and so forth.

In another example, the method may also include designating one optical measurement device as a standard, and comparing other optical measurement devices to the standard for consistent calibration at the different print facilities. The optical measurement device designated as the standard may be physically located at a primary print facility or management center, and not used in the day-to-day operations in order to reduce the effects of daily wear-and-tear, The optical measurement device designated as the standard may also be maintained under known conditions (e.g., temperature, humidity, etc.) and used to adjust other optical measurement devices for variations in conditions at the different print facilities. The optical measurement device designated as the standard may also be used for initializing new optical measurement devices prior to use at one of the print facilities.

In another example, the method may also include removing a portion of the calibration information from the central data store when the portion of the calibration information is outside a threshold boundary. The threshold boundary may include a range of output from the optical measurement device that has been determined to result in printed product which meets one or more expectations (e.g., visually acceptable color, hue, saturation, brightness, etc.). Accordingly, calibration of the optical measurement device may drift within this range and the output may still be used to ensure QC standards. But when calibration has drifted outside of this range, output from the optical measurement device may still be received at the central data store before the optical measurement device is recalibrated. Such output may adversely affect analysis of the output from the other optical measurement devices, and therefore, may be removed from (or otherwise designated/compensated in) the central data store.

It is noted that the exemplary embodiments shown and described are provided for purposes of illustration and are not intended to be limiting. Still other embodiments are also contemplated for optical measurement device calibration.

1. A method comprising:
receiving calibration information from a plurality of optical measurement devices (200) at a central data store (124), the calibration information comprising at least real-time measurement data stored on the plurality of optical measurement devices, the plurality of optical measurement devices each at different print facilities;
analyzing at least one trend in the calibration information at the central data store; and
issuing an instruction to at least one of the plurality of optical measurement devices to update a calibration parameter in the at least one optical measurement device based on the at least one trend.

2. The method of claim 1, further comprising:
receiving registration information from one of the plurality of optical measurement devices when one of the plurality of optical measurement devices (200) is online; and
wherein issuing the instruction is based in part on the device registration information and in part on collective device calibration information.

3. The method of claim 1, further comprising:
designating one optical measurement device (200) as a standard; and
comparing other optical measurement devices to the standard for consistent calibration at the different print facilities.

4. The method of claim 1, further comprising removing a portion of the calibration information from the central data store when the portion of the calibration information is outside a threshold boundary.

5. The method of claim 1, further comprising operating in each of the following use-cases:
a first use-case wherein the plurality of optical measurement devices (200) are initially calibrated in the field at the different print facilities based on analysis of the calibration information at the central data store;
a second use-case wherein the plurality of optical measurement devices (200) are already calibrated and the plurality of optical measurement devices are updated based on control parameters external to the plurality of optical measurement devices; and
a third use-case wherein the plurality of optical measurement devices (200) provide optical measurements for developing targeted consistent ink compositions specific to each of the different print facilities.

6. A system plurality for use with a plurality of optical measurement devices (200) at different print facilities, the system comprising:
a data store (124) configured to establish a connection with the plurality of optical measurement devices at the different print facilities, the data store receiving calibration information from the plurality of optical measurement devices
a processor configured to execute program code stored on computer-readable storage, the program code when executed:
accessing the calibration information from the data store;
analyzing at least one trend in the calibration information, the at least one trend based on at least real-time measurement data from the plurality of optical measurement devices; and
issue an update instruction to at least one of the plurality of optical measurement devices to update a calibration parameter in the at least one optical measurement device based on the at least one trend.

7. The system of claim 6, wherein the program code is further executable to issue a registration instruction to a new optical measurement device (200) based in part on device registration information received from the new optical measurement device, and based in part on collective device calibration information.

8. The system of claim 6, wherein the program code is further executable to compare the plurality of optical measurement devices (200) to a standard optical measurement device for consistent calibration across the different print facilities.

9. The system of claim 6, wherein the program code is further executable to remove from the analysis at least a portion of calibration information associated with an out-of-spec optical measurement device (200) until the calibration information from the out-of-spec optical measurement device is within a threshold boundary.

10. The system of claim 6 operable in each of the following use-cases:
a first use case wherein the plurality of optical measurement devices (200) are initially calibrated in the field at the different print facilities based on analysis of the calibration information at the central data store;
a second use case wherein the plurality of optical measurement devices (200) are already calibrated and the plurality of optical measurement devices are updated based on control parameters external to the plurality of optical measurement devices; and
a third use-case wherein the plurality of optical measurement devices (200) provide optical measurements for developing consistent ink composition specific to each of the different print facilities.

11. A networked calibration system configured for at least one optical measurement device (200) gathering real-time optical data, the networked calibration system comprising:
a central data store (124) configured to communicatively couple with the at least one optical measurement device to receive calibration information including at least the real-time optical data;
a processor operably associated with the central data store, the processor executing program code stored on a computer readable storage to analyze at least one trend in the calibration information; and
a sending unit operably associated with output from the processor, the sending unit configured to issue a configuration instruction to the at least one optical measurement device to update a calibration parameter in the at least one optical measurement device based on the at least one trend.

12. The networked calibration system of claim 11, wherein the sending unit is further configured to issue an initialize instruction based in part on device registration information from the at least one optical measurement device (200).

13. The networked calibration system of claim 11, further comprising:
an optical standard; and
wherein the at least one optical measurement device (200) is compared to the optical standard for consistent calibration under different operating conditions.

14. The networked calibration system of claim 11, further comprising a filter for removing a portion of the calibration information from the central data store (124) when the at least one optical measurement device (200) is operating outside a threshold boundary.

15. The networked calibration system of claim 11 configured to operate in each of the following use-cases:
a first use-case wherein the plurality of optical measurement devices (200) are initially calibrated in the field at the different print facilities based on analysis of the calibration information at the central data store;
a second use-case wherein the plurality of optical measurement devices (200) are already calibrated and the plurality of optical measurement devices are updated based on control parameter external to the plurality of optical measurement devices; and
a third use-case wherein the plurality of optical measurement devices (200) provide optical measurements for developing consistent ink composition specific to each of the different print facilities.
